(19) United States
(12) Patent Application Publication
(10) Pub. No.: US 2005/0053649 A1
(43) Pub. Date: Mar. 10, 2005

(54) Medication delivery device

(76) Inventor: Anne-Marie Chalmers, Osprey, FL (US)

Correspondence Address: LAHIVE & COCKFIELD, LLP., 28 STATE STREET, BOSTON, MA, 02109, US

(21) Appl. No.: 10/785,903

(22) Filed: Feb. 24, 2004

Related U.S. Application Data
(63) Continuation-in-part of application No. 10/657,521, filed on Sep. 8, 2003.
(63) Continuation-in-part of application No. 10/690,387, filed on Oct. 21, 2003.

(51) Int. Cl. A61J 7/00

(52) U.S. Cl. 424/451

(57) ABSTRACT

A medication delivery device by virtue of which multiple medications, each itself in a separate inner container (gel cap, coated pill or capsule), with the multiple separate containers themselves being contained within an outer container which is ingestible or insertable into a live body, and which outer container is made of a material which is biodegradable after ingestion or insertion into a live body, in which each separate inner container is of a particular standardized shape and size designed to fit closely together with each other, thereby resulting in minimum void space, minimum inert ingredients and maximum amount of active ingredients of medication containable within each inner container, and a standardized outer container shape, size and appearance. The outer container is typically a capsule type device, comprised of two components, with the length of the internal compartment of the said outer container capsule type or cylindrical shaped device being variable to accommodate a variety of volumes of internally contained multiple medications. The active ingredients in each of the inner containers is not in actual physical contact with the active ingredients of any of the other medication products also contained within the outer container. The several inner containers, and the outer container, of the medication delivery device may be variously constructed of material which is either opaque, translucent or transparent.

### CROSS-REFERENCE TO RELATED APPLICATIONS

This Application is a Continuation-in-Part of application Ser. No. 10/657521 entitled Medication Delivery Device, filed by the same sole inventor as herein with the United States Patent and Trademark Office on Sept. 8, 2003, which application is pending; and is also a Continuation-in-Part of application Ser. No. 10/690387, filed by the same sole inventor as herein with the United States Patent and Trademark Office on Oct. 21, 2003, which application is pending.

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISK APPENDIX

Not Applicable

### BACKGROUND OF INVENTION

This invention relates to a device for the simultaneous delivery into a live body of multiple medication products, pharmaceuticals, nutritional products and inert materials.

Most medications presently ingested by patients contain significant amount of inert materials or fillers. These inert materials are generally present due to the concentrated nature, and thus small volume, of the actual active ingredient in the medication. If only the active ingredient was presented to a patient, it would be of a size which was too small for the patient to comfortably handle, resulting in either the patient dropping or losing the medication or the patient ingesting an overdose of the medication.

As used herein, the words “pill”, “tablet”, “capsule”, “gel cap” and “soft-gel” are used interchangeably (unless the context at any section hereof otherwise dictate to the contrary, or unless specifically otherwise limited in scope at a particular section hereof), and encompass all other mechanisms and means for delivery of medication products into a live body, including but not necessarily limited to pills, tablets, capsules, gel caps or soft-gels.

As used herein, “Pill” means and includes pills, tablets, capsules, gel caps, soft gels and all other mechanisms and means for delivery of medication products to a live body.

As used herein, the words “medication product” includes and encompasses, but is not limited to, prescription drugs, non-prescription drugs, over-the-counter drugs, nutritional supplements and inert “filler” materials used in conjunction with any of the foregoing.

As used herein, the words “container” and “containment means” includes and encompasses not only the traditional medication capsule, pill, gel cap, soft-gel, suppositories, skin patches and sublingual applications, but also includes and encompasses any and all other medication delivery mechanisms and means.

As used herein, the words “outer container” means the container or containment means which contains multiple medication products as pills, capsules, gel-caps, soft gels, or liquids, but which itself is not connected with or affixed to another or further container or containment device in chain, train or string fashion, and which is not itself sequentially imbedded within another container, and which said non-connected and non-affixed container or containment means can be ingested or inserted into a live body.

Many studies show that age is strongly correlated to the number of prescription medication Pills a person is taking. Due to a continually increasingly aging population and increased use of drug therapy, more and more older people find themselves often taking several (perhaps as many as 4 to 10) Pills for treating or preventing illnesses every day. Research has shown that even patients for whom strict adherence to prescribed drug regimens is crucial, rates of non-compliance can still range from as much as 20% to 50%.

Each year in the United States, the consequences of poor compliance cost an estimated $100 billion in added health care expenses, lost productivity, and other direct and indirect costs, in addition to personal suffering.

Another consequence of people having to take several Pills every day, is that it increases the risk of mix-ups, for example, the patient becomes confused as to whether they have taken their medications or not. It is then possible that they take too much or too little of their medications; this results in side effects from drugs more likely to happen.

It is sadly ironic that the more confused the patient is, the more likely it is that they have even more Pills to keep track of and monitor.

According to the United States Food and Drug Administration, 1.5 million Americans were hospitalized in 1978 alone as a consequence of pharmaceutical drugs administered to “cure” them, It was found that some 30% of all hospitalized people suffered further damage from the therapy prescribed to them.

Side effects involving prescription drugs are the fifth leading cause of deaths in the USA.

One means of increasing compliance is to reduce the number of Pills taken per day, thus reducing patient resistance to swallowing large numbers of Pills or the possibility of patients forgetting to take some of their medication, thus reducing the number of Pills taken per day, and reducing the risk of medication-induced error.

Moreover, numerous studies have shown that certain combinations of different substances or medications can dramatically improve the health outcomes through additional or synergic effects. But these combinations most often require the ingestion of more Pills which may again lower the compliance.

The delivery of medication products, including prescription drugs, over-the-counter drugs, nutritional supplements and inert materials, has been traditionally accomplished by the use of Pills.

Typically Pills are comprised of the active ingredient compounded with inert ingredients for various purposes, including ease of handling small amounts of active ingredients. When the said mixture of active and inactive ingredients is then compressed to form a “pill”, that pill typically is then coated or covered with a polished “surface” substance functioning as both a physical/chemical barrier and as a helper for smooth swallowing. Very often medications can come in a dose of only a few milligrams, but since this amount is so small and unmanageable, the size of the pill has to be increased substantially with fillers Similarly, capsules, gel caps and soft-gels are composed of an outer material or casing which is dissolved after ingestion by the patient. The interior portion of the capsule, gel caps or soft-gel is filled with an active ingredient compounded with inert ingredients for various purposes, including ease of handling of small amounts of active ingredients, similar to a pill as described above.

There are several distinctions between capsules vis-à-vis soft gels or gel caps. The major difference between a capsule and a soft gel or gel cap is that a capsule is a hard shell and a soft gel or gel cap is physically a softer gelatin container. A soft gel or gel cap is essentially a capsule made from gelatin, usually from a bovine or pig source, although there are also available soft gels made from vegetable sources, e.g., potato starch. A capsule, on the other hand, is generally made from many different materials, including gelatin formulations. Capsules usually contain solid materials such as powders, although they occasionally do contain liquids, whereas soft gels or gel caps usually contain oils or liquid, although some soft gels or gel caps do contain rather powdery substances in soft gels or gel caps, which facilitate the swallowing process.

A sub-category or variation of gel caps is “liquid gel caps”. The interior of these gel caps are filled with liquid rather than solid materials, typically a blend of active and inactive ingredients. The liquid gel caps provide an easy means of carrying liquid medications for ingestion without the need to transport the liquid from a liquid container to the mouth of the patient. Thus the risk of liquid bottle spillage or breakage is avoided.

The disadvantage of a typical prescription Pill is that it usually contain only one primary medication thus only addresses one type of indication or problem.

The treatment of many seriously ill or chronic patients requires the use of multiple medications. Many patients find having to take numerous traditional Pills is burdensome and restrictive, and causes additional responsibility and worries. Not only is the patient burdened with multiple containers for the various medications, but the patient must also track each Pill to assure that they have in fact timely ingested the proper dosage of each such medication.

To generate a “tracking system”, it is well known many patients hesitate to switch to cheaper generic substances, because patients use, for example, the heart shaped form of medication for one ailment or the soothing shade of sky blue color of medication for another ailment to help them recognize their medication. The pharmaceutical industry brands their drug products by offering them in a wide array of different shapes, sizes and colors. Although this helps the patient to recognize their numerous individual Pills, but it also makes prescription medication treatment more expensive than necessary. This is due not only to production and marketing costs but also because the patients are hesitant to try unrecognizable generic versions.

The present invention reflects the fact that: (1) Most people do not experience any problems swallowing oblong capsules up to the size of 8 mm in diameter and twenty five (25) mm in length, although this size is somewhat larger than most of the prescription Pills on the market; (2) Keeping track of one large Pill is easier than keeping track of numerous small Pills; (3) Many prescription drugs come in Pill sizes larger than chemically necessary and the active ingredient is often so minute it needs to be sized up with fillers to become manageable for the consumer, or it needs to fit a specific shape for marketing purposes; and (4) There are presently no national or international standards for sizes, shapes or colors for Pills; instead even the same generic component can come in a variety of appearances to reflect the manufacturers brand. This makes it confusing and difficult for the patient to switch from one manufacturer to another for the same medication.

Combining the fact that it is physically possible to add many prescription drugs together in the one container, and still maintain a Pill size which is easier to swallow, opens up the possibility of solving the above compliance problems and reducing the risk of taking too much or little medication.

An objective of the present invention is to solve the aforesaid problems, including by reducing the number of Pills that will contain the originally intended, prescribed or recommended medications and doses, thus increasing compliance and reducing the possibility of confusion.

A further objective of the present invention is also to solve the aforesaid problems by is that by facilitating a switch, in certain instances, to relatively less expensive generic products.

A yet further objective of the present invention is also to solve the aforesaid problems by enabling a world wide patient individualized manufacturing systems/ fulfillment centers/pharmacies based on international standards for size and configuration of Pills.

### BRIEF SUMMARY OF THE INVENTION

A medication delivery device by virtue of which multiple medications are produced in a standardized distinctive shape or shaped container, and adjusted unit sized Pills which are configured and designed such that when inserted into and contained within an ingestible or insertable container which is biodegradable within a live body, the said medications which are in containers which are then contiguous with each other fit snugly against each other to thereby minimize void space. Since each such container is inside a larger manageable sized outer container it does not need to be handled separately. The need for an inert volume increase becomes unnecessary and thus allows for the manufacturing of the smallest containers possible. This makes it possible to stack even more “pills” inside the outer container before reaching the ingestible size limit. It also assures the maximum amount of active ingredients of medication is containable within the smallest outer containment means.

The said outer containment means is typically a capsule type device, comprised of an elongated cup-shaped component with the length of the internal compartment of the said outer containment means being variable to accommodate a variety of volumes of said multiple medications, which outer containment means is biodegradable within a live body.

The active ingredients in each of the said medications is not in actual physical contact with the active ingredients of the medication product with which it is contiguously situated within the said outer containment means because of the surface barrier between each of them.

One of the medication containers can itself be a component of the biodegradable ingestible container.

The several components of the said medication delivery device which is the invention herein may be variously constructed of material which is opaque, translucent or transparent.

### BRIEF DESCRIPTION OF THE DRAWINGS

FIG. 1 is a depiction of an assemblage of different medications, depicted for illustration purposes as one pill, two capsules of different sizes, and a gel cap.

FIG. 2 is a depiction of the medications which had been depicted in FIG. 1, but with those medications shown in FIG. 2 as now being in pill form, with each pill being of a particular shape and size, with the diameter of each such pill being uniform and the thickness of each such pill varying and being dependent upon the dosage of the medication of which each such pill is comprised.

FIG. 3 is a depiction of an embodiment of an outer medication containment means, comprised of a female component and a male component.

FIG. 4 is a depiction of the several medications in particular shapes and sizes as had been depicted in FIG. 2 now being contained within the outer medication containment means which had been depicted in FIG. 3.

FIG. 5 is a depiction of a composite form of outer container, as to which one part of the said outer container is one-half of a traditional capsule, and the other part of the outer container is a plug, a portion of which is inserted into the open end of the said one-half capsule.

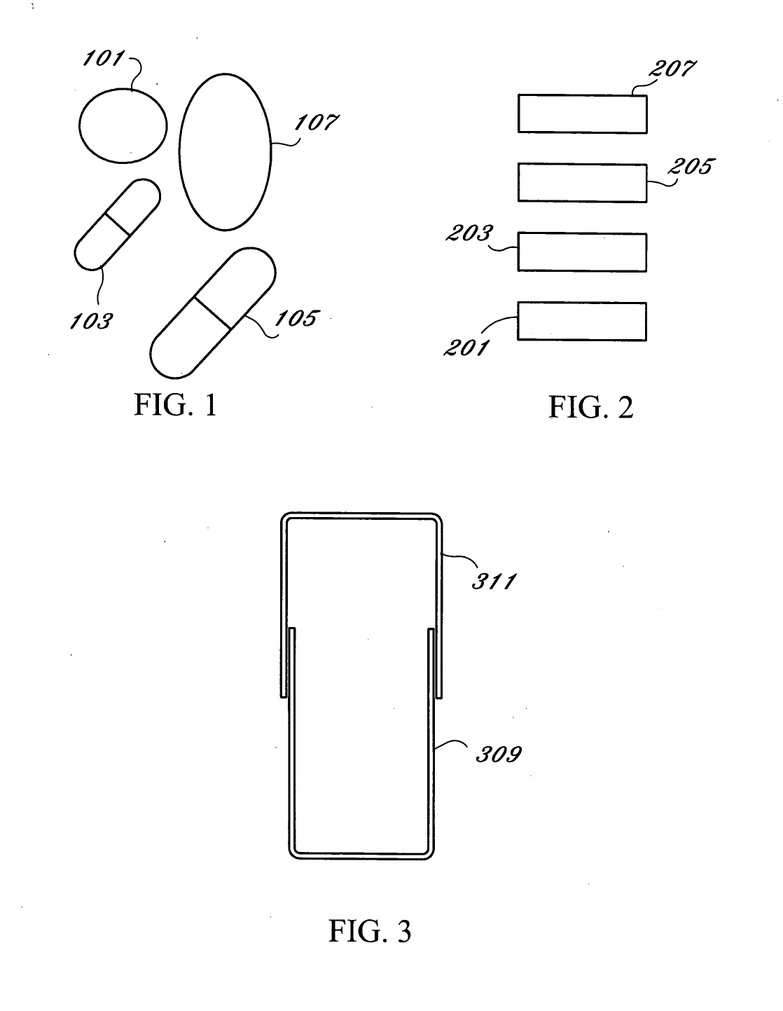

These FIGS. 1 through FIG. 5 are not necessarily exhaustive of all embodiments of the invention.

### DETAILED DESCRIPTION OF THE INVENTION

A medication delivery device, as exemplified by the several preferred embodiments depicted in FIGS. 1 through 5, provides for the delivery to a living body, human or animal, of a maximum amount of active ingredients, with a minimum amount of inert materials, of multiple medication products simultaneously.

Although the more typical method and means for entry into the said living body is by ingestion, the invention also encompasses other forms of such entry, including but not limited to suppository form or application to the skin.

As depicted in FIG. 1, a patient who is prescribed numerous medication products is not infrequently confronted with a plurality and a variety of means for delivery of each such medication, including a pill (101), a small capsule (103), a large capsule (105) and a gel cap (107).

The present invention includes reformulating each of such medication products to eliminate or minimize inactive ingredients, thus reducing the physical volume of each such means for delivery, and importantly shaping and configuring the physical outer appearance of each such medication product so that when inserted together with other such medication products into an outer container, they each fit snugly with those to which they are then contiguous.

FIG. 2 depicts the medication products which had been depicted in FIG. 1 as (101), (103), (105) and (107) in newly shaped and sized pill forms depicted in FIG. 2 as (201), (203), (205) and (207), respectively.

The diameter of each said pill (201), (203), (205) and (207) is the same, with that diameter having a minimum measurement consistent with the capabilities of pharmaceutical manufacturing equipment and a maximum measurement consistent with the size of a capsule of medication easily swallowed by a living body in the category of living bodies to which the particular medication is applicable, or easily inserted as a suppository into the appropriate orifice of a living body in the category of living bodies to which the particular medication is applicable.

A capsule with a diameter of eight (8) mm and a length of twenty-five (25) mm is generally considered to be the maximum comfortable size for oral ingestion by human adults.

One embodiment of an outer container into which the said shaped forms of the medications (201), (203), (205) and (207) are to be inserted is depicted in FIG. 3 for illustration purposes as a typical medication capsule of cylindrical form, being comprised of a male component (309) and a female component (311). The male component (309) is intended to be inserted into the female component (311).

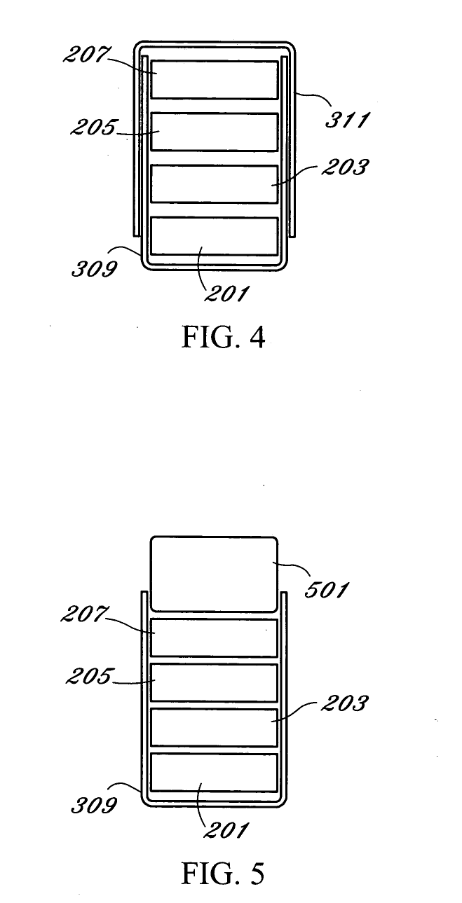

As shown in FIG. 4, the said pill shaped forms of medication (201), (203), (205), and (207), are inserted into the male component (309) of the capsule, after which the male component (309) of the capsule is then inserted in the female component (311).

Alternatively, as depicted in FIG. 5, the closure means by virtue of which pills, such as (201), (203), (205) and (207), which had been inserted into capsule section (309), are retained therein is the use of a plug, (501).

Plug (501) can be composed of inert material, or it can itself be a further medication product which is either in gel cap, capsule of pill form. A typical medication readily contained in plug (501) would be Omega 3, or vitamins, or calcium, or other common dietary supplements. When Plug (501) is in gel cap form, it is readily suitable to containing liquid medications.

Plug (501) is inserted into the open end of the said half-capsule (309), thereby preventing the inadvertent discharge or spillage of pills (201), (203), (205) and (207) from the said one-half capsule (309).

Plug (501) can be affixed to the half-capsule (309) either by permanent means, such as glue or shrink-wrap sealing, or by temporary means, such as mere friction between the mating surfaces of plug (501) with the inside wall of half-capsule (309).

The use of pills (rather than powders) as the form of medication (201), (203), (205) and (207) avoids the irretrievable aspect associated with powders, in addition to the inability to assure proper dosage when powder medications are spilled, in the event that the outer container, whether as depicted in FIG. 3 or in FIG. 4, or otherwise, is opened, wither inadvertently or intentionally.

Although the foregoing embodiments refer variously to pills, gel caps and capsules, the invention is not limited to pills, gel caps and capsules as specifically shown and discussed herein, but rather encompasses any and all medication containers and containment means, including pills, gel caps and capsules.

In addition, although several of the preferred embodiments described hereinbefore are comprised, for illustration purposes, of a specific number of capsules, gel caps or pills, or combinations thereof, the invention is not limited to a specific number of capsules, pills and/or gel caps, but rather encompasses any number of containers or containment means.

This invention allows for all kinds of medication combinations, including solids and liquids, since they are all kept inside their own separate spaces/containers and it permits incompatible substances like oils and water to be stored separately inside the same outer container.

The active ingredients contained within each medication product are separated from the other active ingredients contained within the same said outer containment device by the physical properties of each medication product so coated, typically by coatings on pills or by being capsules or gel caps, thereby preventing the medication substance in one container compartment from mixing with the medication substance in the other container compartments.

Consequently, there is no concern about the medication substances starting to react with each other within the most outer container compartment, and the medications substances will therefore not represent a new chemical compound, before being ingested or otherwise delivered into a live body.

The highly economically attractive and flexible prospect of different medication substances actually being produced at locations distant from each other and then being consolidated in medication delivery devices in accordance with this invention become feasible, and indeed economically attractive.

The numerous advantages of this invention include: (a) The ability to maintain the chemical stability of the different medication substances, by preventing any chemical reaction between or among them by virtue of the fact that they are separated from each other by being in separate containers and compartments; (b) ease of production of a means to deliver multiple medications simultaneously, by virtue of each container compartment being capable of being produced and filled with different medications at remote distant locations, before the final assemblage; (c) since the active ingredients are inside one outer container, the patient will not need to recognize the individual pills, which will facilitate the switch to less expensive generic substances, when that is feasible, because prescription costs are thereby reduced; (d) flexibility, since the content or concentration can be changed for one substance without influencing the chemical properties of the other; (e) increased intestinal absorption, since the. bio-availability is usually higher for soft gels and capsules compared to tablets or pills; (f) increased patient compliance and assurance that the patient is actually taking several medical substances since they come as “one dose”; (g) increased patient compliance because the patient will be more willing to take one pill compared to several; (h) reducing the risk of medication confusion both for the patient and/or the staff at for example nursing homes, hospitals, since there will be fewer pills to kept track of; (i) high patient compliance because patients often have an easier time swallowing a capsule or soft gel or gel cap compared to a table or pill; and (j) a precise “medical” communication, because it shows clearly which products are combined (not mixed), and thus opening the area of “synergy” medicine.

It is contemplated that the inventive concepts herein described may be variously otherwise embodied and it is intended that the appended claims be construed to include alternative embodiments of the invention except only insofar as limited by prior art.

Furthermore, by standardizing the diameter and the shape of the different medication products as described herein, it becomes possible to thereby obtain an optimal physical configuration that favors the swallowing reflex of a live body and also reduces the “dead” space to a minimum, thus making the total volume of the medicinal delivery device as small and as compacted as possible and holding as many active ingredients inside as possible.

In addition, by standardizing the diameter and the shapes of the different containers, it becomes possible to customize the medicinal product delivery device to the individual patient. The ability to interchange the same shape and adjusted size components allows for the manufacturing of different variation of inner component medications. The dosages can also be individualized by repeating one medication container in order to get, for example, a double dose.

Also by standardizing the diameter and the shape of the different containers, we allow for putting many medications into “one” Pill, rather than the otherwise need to use several.

Another advantage of the invention is that by standardizing the diameter and the shape of the different containers, it becomes possible to build standardized automated feeding machines for an assembly line. The medical prescription coming from a physician can then be translated into the invented customized delivery system, adjusted to the patient's weight, sex, and age, simply by using multiple inner container feeders, each holding different medications. Thus making a means for creating a new international industry consisting of combined assembly line/fulfillment centers/pharmacies that can communicate directly with the physicians or prescription centers all over the world, to produce these individualized multi medication devices based upon a single digital classification system merely referring to for example color, ingredient and does or a reference number.

1. A device for the simultaneous delivery of multiple medication products to a live body, with such device comprising:
a first medication delivery means shaped in a first physical external configuration;
a second medication delivery means shaped in a second physical external configuration;
an outer containment means shaped in a third physical configuration, into which said outer containment means the said first medication delivery means and the second medication delivery means are sequentially inserted or embedded;
wherein the said first physical external configuration of the said first medication delivery means is such that, when the said first medication delivery means is inserted into the said outer containment means, the surface of the circumferential side wall of the said first physical configuration of the said first medication delivery means is in contact with the interior side wall of the said outer containment means, and the said first medication delivery means is inserted into the said outer containment means to the full extent possible;
wherein the said second physical external configuration of the said second medication delivery means is such that, when the said second medication delivery means is inserted into the said outer containment means, subsequent to the said first medication deliver means having been inserted into the said outer containment means, the surface of the circumferential side wall of the said second physical configuration of the said second medication delivery means is in contact with the interior side wall of the said outer containment means, and when the said second medication delivery means is inserted into the said outer containment means to the full extent possible it, the bottom of the planer, non-circumferential surface of the said second medication containment means is in physical contact with the top of the planer, non-circumferential surface of the said first medication containment means;
enclosure means to prevent the inadvertent ejection of either the said first medication means or the second medication means, or both of them, from the interior of the said outer containment means; and
wherein the said outer containment means is biodegradable within a live body.

2. The invention of claim 1 in which the physical configuration of the outer containment means is a capsule, and the physical configuration of each of the inner medication delivery means is a pill.

3. The invention of claim 1 in which the physical configuration of the outer containment means is a capsule, and the physical configuration of each of the inner medication delivery means is a combination of pill and capsule.

4. The invention of claim 1 in which the physical configuration of the outer containment means is a combination of pill and capsule, and the physical configuration of each of the inner medication delivery means is a pill.

5. The invention of claim 1 in which the physical configuration of the outer containment means is a combination of pill and capsule, and the physical configuration of each of the inner medication delivery means is a combination of pill and capsule.

6. The invention of claim 2 in which the diameter of the said pill is no larger than the diameter of an object intended to be swallowed easily by a live person.

7. The invention of claim 2 in which the diameter of the said pill is no larger than 8 mm.

8. The invention of claim 2 in which the thickness of the said pill is of a size which is in proportion to the amount of active ingredient contained within said pill.
